(19) United States
(12) Patent Application Publication
(10) Pub. No.: US 2003/0029423 A1
(43) Pub. Date: Feb. 13, 2003

(54) Method, computer program, control and/or regulating unit, and fuel system for an internal combustion engine, in particular with direct injection

(76) Inventors: Peter Boehland, Marbach (DE); Wolfgang Brosig, Schwaebisch-Gmuend (DE); Godehard Nentwig, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/214,164

(22) Filed: Aug. 8, 2002

(30) Foreign Application Priority Data
Aug. 8, 2001 (DE) 1 01 39 054.8

(51) Int. Cl. F02M 1/00

(52) U.S. Cl. 123/450; 123/446

(57) ABSTRACT

A method of operating internal combustion engine in which a first fuel pump delivers fuel from a fuel tank, and at least a part of the delivered fuel travels via at least one inlet valve into at least one working chamber of a second fuel pump embodied as a positive-displacement pump which delivers the fuel to a fuel accumulation line. In order to increase the efficiency during operation of the engine, the inlet valve opens when there is a particular pressure difference between the working chamber and a region upstream of the inlet valve and that the pressure upstream of the inlet valve is changed in order to change the relative opening duration of the inlet valve and therefore the fuel quantity arriving into the working chamber of the second fuel pump.

### BACKGROUND OF THE INVENTION

1. Field of the Invention

The current invention relates to a method for operating an internal combustion engine, in particular with direction injection, in which a first fuel pump delivers fuel from a fuel tank and in which at least a part of the delivered fuel travels on via at least one inlet valve into at least one working chamber of a second fuel pump embodied as a positive-displacement pump, which delivers the fuel to a fuel accumulation line.

2. Description of the Prior Art

A method of operating an internal combustion engine in the above manner is known from DE 199 26 308 A1, which discloses a pump apparatus for fuel, which has a main delivery pump embodied as a high-pressure pump, preceded by a presupply pump. The presupply pump is embodied as a mechanical fuel pump and delivers a fuel flow from a tank via a fuel line. The main delivery pump is a radial piston pump driven by a camshaft. The radial piston pump feeds into a fuel accumulation line, which is also commonly referred to as a “rail”. From the fuel accumulation line, in which the fuel is stored at high pressure, the fuel travels to the injection valves, which supply the fuel to combustion chambers of the engine.

An inlet valve, which is embodied as the check valve, is provided at the entry to the working chamber of the positive-displacement pump. During a displacement stroke of the piston, this inlet valve closes the working chamber off from the region oriented toward the presupply pump. The known pump apparatus is provided with a metering unit between the presupply pump and the main delivery pump. This metering unit can throttle the influx of fuel into the working chamber of the pump so powerfully that it is only partially filled or is not filled at all. This serves to reduce the drive moment of the main delivery pump in those cases in which the main delivery pump should not supply the entire fuel quantity. For example, this is the case when the injection valves inject only a small amount of fuel into the combustion chamber of the engine.

In order to achieve the throttling, it must be possible for the throttle valve used to be precisely adjusted over a broad range. However, a throttle valve of this kind is expensive. Moreover, when a throttle valve is used, even when the valve is completely open, the pressure always drops by a certain amount due to the presence of the valve. This can lead to a reduction in the efficiency of the pump apparatus.

### OBJECT AND SUMMARY OF THE INVENTION

The object of the current invention, therefore, is to modify a method of the type mentioned above so that the associated internal combustion engine is less expensive to produce and operates with a higher efficiency.

This object is attained with a method of the type mentioned above in that the inlet valve opens when there is a particular pressure difference between the working chamber and a region upstream of the inlet valve and that the pressure upstream of the inlet valve is changed in order to change the relative opening duration of the inlet valve and therefore the fuel quantity arriving into the working chamber of the second fuel pump.

With the method according to the invention, a throttle valve between the first and second fuel pump can be eliminated. This reduces the costs of producing the pump apparatus and consequently also the costs of producing the engine. Furthermore, the full cross section is available at any time for the delivery of fuel so that no pressure losses occur upstream of the second fuel pump, or at least none of any consequence. This considerably increases efficiency during operation of the engine.

These advantages according to the invention are achieved by virtue of the fact that the fuel quantity that travels into the working chamber of the second fuel pump is achieved not by narrowing the cross section of the inlet, but by limiting the time during which the fuel can travel into the working chamber of the second fuel pump. The “relative” opening duration of the inlet valve here is not understood to be an absolute time value, but an opening time that relates the duration of a working stroke of the pump elements associated with the corresponding working chamber.

The invention first proposes that in order to achieve a maximal opening duration of the inlet valve, the pressure in the region upstream of the inlet valve is increased to a pressure, which approximately corresponds to the maximal permissible pressure for the first fuel pump. The maximal opening duration of the inlet valve means in general that the inlet valve is open during the entire intake stroke in the working chamber and consequently, the second fuel pump executes a maximal delivery. The combination of this maximal opening duration of the inlet valve with the maximal permissible pressure for the first fuel pump permits a broad pressure range to be used for adjusting the opening duration. This in turn leads to a relatively high degree of precision in the adjustment of the opening duration of the inlet valve.

Analogously, the invention proposes that in order to achieve a minimal opening duration of the inlet valve, the pressure in the region upstream of the inlet valve is reduced to a pressure, which approximately corresponds to the minimal pressure required for a lubrication of the second fuel pump. This modification is based on the concept that a part of the fuel flow delivered by the first fuel pump to the second fuel pump is used for the lubrication of the second fuel pump. Another purpose of this branching of a fuel flow is the cooling of the second fuel pump. This modification of the method according to the invention also broadens the pressure range available for controlling the opening duration of the inlet valve, which has a favorable effect on the precision of the opening duration adjustment.

Another particularly preferable modification of the method according to the invention is the one in which the inlet valve does not open when the pressure in the region upstream of the inlet valve is minimal. In this instance, an actual zero-delivery of the second fuel pump can be achieved, which is advantageous, for example, during overrunning of the engine.

The invention also proposes that the desired driving torque of the engine is at least indirectly used to determine a reference opening duration of the inlet valve of the second fuel pump and/or a reference pressure in a region upstream of the inlet valve of the second fuel pump. This modification of the method according to the invention has the advantage of permitting an extremely rapid reaction to the fuel requirements that correspond to the desired driving torque and consequently, the driving torque of the second fuel pump is minimal in every operating state of the engine.

The invention also relates to a computer program, which is suitable for executing the method of the type mentioned above, when it is run on a computer. It is particularly preferable if the computer program is stored in a memory, in particular a flash memory.

The invention also relates to a control and/or regulating unit for controlling and/or regulating at least one function of an internal combustion engine. In order to be able to embody the operation of the engine in the most favorable possible manner with regard to efficiency, the invention proposes that the control and/or regulating unit is provided with a computer program of the type mentioned above.

The invention also relates to a fuel system for an internal combustion engine, in particular with direct injection, having a fuel tank, a first fuel pump that delivers from the fuel tank, and a second fuel pump embodied as a positive-displacement pump with at least one working chamber, which is connected on the inlet side by means of at least one inlet valve to the first fuel pump and is connected on the outlet the side to a fuel accumulation line.

A fuel system of this kind is known from the above-mentioned DE 199 26 308 A1. In order to improve the efficiency during operation of a fuel system of this kind, and in order to reduce the costs for the fuel system, the invention proposes that the inlet valve opens when a particular pressure differential exists between the working chamber and a region upstream of the inlet valve and that a pressure adjusting device is provided, which can adjust the pressure in the region upstream of the inlet valve, so that influence can be exerted on the relative opening duration of the inlet valve and on the quantity of fuel arriving into the working chamber of the second fuel pump. With respect to the advantages of this, reference is hereby made to the explanations given above.

In a modification to this, the invention proposes that the inlet valve includes a prestressed check valve. This component is simply designed and inexpensive.

Advantageously, the pressure adjusting device includes an electrically adjustable pressure control valve, which is connected on the outlet side to a return. A pressure control valve, which limits the pressure downstream of the first fuel pump to a particular maximal value is provided anyway in conventional fuel systems. An electrically adjustable pressure control valve therefore incurs only slight cost increases—if any at all—and is operationally reliable. Particularly in connection with a first fuel pump that is embodied as an electric fuel pump and in this respect, achieves a constant delivery capacity, a pressure control valve of this kind can be used to adjust the pressure in the region between the first fuel pump and the second fuel pump in a simple manner.

A particularly preferable modification of the fuel system according to the invention is the one in which the inlet valve is embodied so that it remains closed when a pressure in the region upstream of the check valve lies in the vicinity of the minimal opening pressure of the pressure control valve. In a simple fashion, this permits a fuel system to be achieved in which a zero-delivery to the injection valves is possible.

Analogously to this, it is advantageous if the inlet valve is embodied so that it is open essentially during the entire intake stroke of the second fuel pump when a pressure in the region upstream of the inlet valve lies in the vicinity of the maximal opening pressure of the pressure control valve. In a simple fashion, this produces a full delivery and the entire pressure range possible in the low pressure region of the fuel system, i.e. in the region upstream of the check valve, is used for controlling the opening duration of the check valve.

For safety reasons, though, it is advantageous if the opening pressure of the pressure control valve is minimal when it is without power. In the event of an interruption in the power supply or a failure of the control unit, this assures that no fuel or only a small amount of fuel reaches the second fuel pump and consequently only a small amount of fuel or no fuel at all can travel into the combustion chambers.

### BRIEF DESCRIPTION OF THE DRAWINGS

The invention will be better understood and further objects and advantages thereof will become more apparent from the ensuing detailed description of preferred embodiments taken in conjunction with the drawings, in which

FIG. 1 shows a schematic representation of a fuel system with a second fuel pump, which is shown in a partially sectional view;

FIG. 2 shows a section through a region of the second fuel pump from FIG. 1; and

FIG. 3 shows a graph in which the piston stroke, the pressure in the working chamber, the pressure upstream of an inlet valve of the second fuel pump, and the opening duration of this inlet valve are depicted over the angle of a drive shaft of the fuel pump.

### DESCRIPTION OF THE PREFERRED EMBODIMENTS

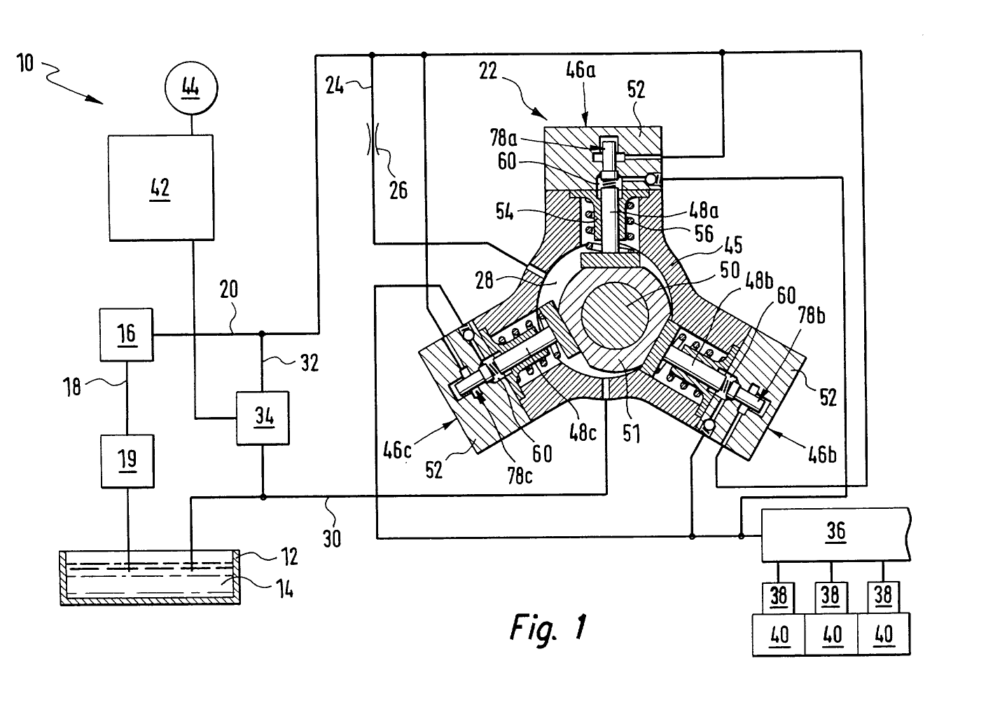

In FIG. 1, a fuel system is labeled as a whole with the reference numeral 10. It includes a fuel tank 12, from which fuel 14 is delivered by an electric fuel pump 16. The fuel pump 16 is connected to the fuel tank 12 by means of a fuel line 18 in which a filter 19 is disposed.

A fuel line 20 leads from the electric fuel pump 16 to a mechanically driven high-pressure fuel pump 22. This high-pressure fuel pump will be discussed in detail further below. Before the high-pressure fuel pump 22, a branch line 24 containing a flow throttle 26 branches off from the fuel line 20. The branch line 24 leads to a drive/crank chamber 28 in the high-pressure fuel pump 22. From this, a return line 30 leads back to the fuel tank 12. Between the electric fuel pump 16 and the junction of the branch line 24, a connecting line 32 branches off from the fuel line 20. This connecting line 32 leads to the return line 30. A pressure control valve 34 is disposed in the connecting line 32. The opening pressure of this pressure control valve can be electromagnetically adjusted.

On the outlet side, the high-pressure fuel pump 22 is connected to a fuel accumulation line 36. Fuel can be stored in this accumulation line at a very high-pressure. The fuel accumulation line 36 is connected to a number of injection valves 38, which can inject the fuel into combustion chambers 40 of the engine (not numbered). The fuel system 10 also includes a control and regulating unit 42, which is connected on the output side, among other things, to the pressure control valve 34. On the input side, the control and regulating unit 42 receives, among other things, signals from a position sensor 44, which senses the position of a gas pedal (not shown).

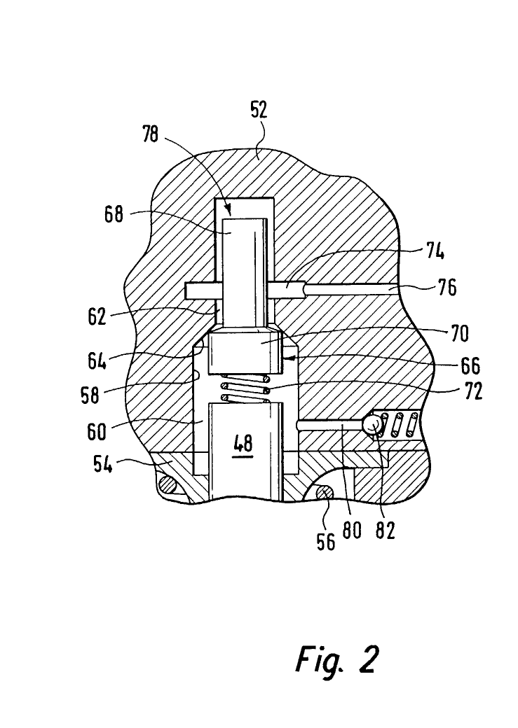

The high-pressure fuel pump 22 is embodied as a radial piston pump. It includes a housing 45, with three cylinders 46a, 46b, and 46c arranged in a star pattern. The cylinders 46a, 46b, and 46c contain pistons 48a to 48c, which can be set into a reciprocating motion by a camshaft 50 by means of a stroke ring 51. The camshaft 50 is disposed in the above-mentioned drive/crank chamber 28, in the radial center of the housing 45. Each cylinder 46a to 46c is radially defined at the outside by a cylinder head 52. The design and function of the cylinder 46a will be explained below in conjunction with FIG. 2 as an example for all of the cylinders 46a to 46c. It should be noted that for the sake of clarity, not all of the reference numerals are furnished in FIG. 1.

The piston 48 is guided so that it can slide in a sleeve 54. This sleeve is pressed against the cylinder head 52 by a compression spring 56. A step-shaped blind bore 58 is provided in the cylinder head 52. Its lower region in FIG. 2 has a larger diameter and defines a working chamber 60, whereas its upper region in FIG. 2 has a smaller diameter and defines an inlet chamber 62. The two regions are separated from each other by conical transition surface, which constitutes a valve seat 64.

The blind bore 58 contains a cylindrical valve element 66. This valve element has an elongated, cylindrical guide section 68 and a head section 70. The head section 70 has a larger diameter than the guide section 68. A compression spring 72, which is clamped between the piston 48 and the head section 70 of the valve element 66, presses the head section 70 against the valve seat 64.

The circumferential surface of the inlet chamber 62 has a circumferential annular groove 74 let into it, into which an inlet conduit 76 feeds. The valve element 66, together with the valve seat 64, constitutes an inlet valve 78, through which fuel can travel into the working chamber 60 and which is designed so that it opens when an approximate pressure difference of 2 bar between the working chamber 60 and the inlet chamber 62 is exceeded. The working chamber 60 is connected to an outlet valve 82 by means of an outlet conduit 80. Like the inlet valve 78, this outlet valve 82 is embodied as a spring-actuated check valve, but its valve element is a valve ball.

The fuel system 10 functions in the following manner: (The detailed functions of the high-pressure fuel pump 22 will, for their part, be described using the example of the cylinder 46a. They also apply analogously to the cylinders 46b and 46c)

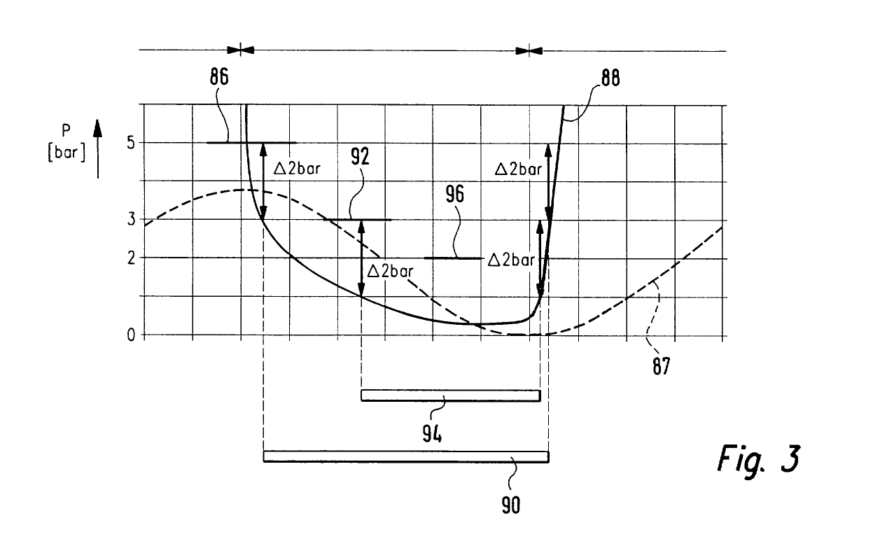

In order to achieve a full delivery, the pressure control valve 34 is triggered by the control and regulating unit 42 so that the pressure in the fuel line 20 between the electric fuel pump 16 and the high-pressure fuel pump 22 is approximately 5 bar. This pressure level is the maximum pressure that can be achieved by the electric fuel pump 16 and is labeled with the reference numeral 86 in FIG. 3. During a delivery stroke (the stroke curve of the piston 48 is labeled with the reference numeral 87 in FIG. 3), the camshaft 50 moves the piston 48 toward the valve element 66 so that the volume of the working chamber 60 is reduced and the spring 72 is compressed. By means of this and due to the pressure difference between the working chamber 60 and the inlet chamber 62, the valve element 66 is pushed with the head section 70 against the valve seat 64. The inlet valve 78 is thus closed. If the pressure in the working chamber 60 is slightly higher than the pressure in the fuel accumulation line 36, the outlet valve 82 opens and the working volume enclosed in the working chamber 60 can be pushed into the fuel accumulation line 36.

After the end of a delivery stroke, an intake stroke begins. In it, the compression spring 56 moves the piston 48 away from the valve element 66 so that the volume of the working chamber 60 increases. This reduces the pressure in the working chamber 60, which causes the outlet valve 82 to close. The inlet valve 78 is also closed at first. The spring 72 and the area ratios on the head 70 of the valve element 66 are designed so that the inlet valve 78 opens only when the pressure in the working chamber 60 is approximately 2 bar less than the pressure in the inlet chamber 62. The curve that represents the pressure in the working chamber 60 is labeled with the reference numeral 88 in FIG. 3. Thus the inlet valve 78 opens as soon as a pressure of less than or equal to 3 bar prevails in the working chamber 60. When the inlet valve 78 is open, then fuel can flow from the fuel tank 12, through the fuel line 18, the electric fuel pump 16, the fuel line 20, the inlet conduit 76, the annular groove 74, and the inlet chamber 62, into the working chamber 60.

When the piston 48 reaches the bottom dead center, the intake stroke ends and a new delivery stroke begins. This means that the camshaft 50 once again pushes the piston 48 toward the valve element 66. Consequently, the pressure in the working chamber 60 increases and the spring 72 is once again compressed. As soon as the pressure difference between working chamber 60 and the inlet chamber 62 is less than 2 bar, the inlet valve 78 closes. Thus in this instance, the opening duration of the inlet valve 78 (pressure in the fuel line 20 or in the inlet chamber 62 of 5 bar) corresponds approximately to the duration of the intake stroke of the piston 48. This duration is indicated in FIG. 3 by a bar graph that is labeled with the reference numeral 90.

If a smaller fuel quantity is to be delivered by the high-pressure fuel 22, then the pressure control valve 34 is triggered by the control and regulating unit 42 so that the pressure in the fuel line 120 is only approximately 3 bar, for example. Correspondingly, a pressure of only approximately 3 bar also prevails in the inlet chamber 62. The pressure level of 3 bar is labeled with the reference numeral 92 in FIG. 3.

Analogous to the above description, the pressure in the working chamber 60 decreases during an intake stroke when the inlet valve 78 is closed and the outlet valve 82 is likewise closed. If the pressure difference between the working chamber 60 and the inlet chamber 62 exceeds approximately 2 bar, then the inlet valve 78 opens. This is the case when there is a pressure of approximately 1 bar in the working chamber 60. As can be seen in FIG. 3, this is considerably later than a pressure of 5 bar in the inlet chamber 62.

After the passage through the bottom dead center and the beginning of the subsequent delivery stroke, the pressure in the working chamber 60 increases again. If the pressure in the working chamber 60 exceeds a pressure of 1 bar or the pressure difference between the inlet chamber 62 and the working chamber 60 is less than 2 bar, then the inlet valve 78 closes. The corresponding opening duration of the inlet valve 78 is likewise depicted in FIG. 3 by means of a bar graph that is labeled with the reference numeral 94. It is easy to see that the opening duration 94 is considerably shorter than the opening duration 90, which was achieved with a pressure of approximately 5 bar in the fuel line 20. A shorter opening duration of the inlet valve 78, however, also means that less fuel can flow into the working chamber 60. Consequently, the fuel quantity arriving into the working chamber 60 and therefore the entire fuel quantity delivered by the high-pressure fuel pump 22 to the fuel accumulation line 36 can be changed or adjusted by reducing the pressure in the fuel line 20.

If a zero-delivery is to be produced, the control and regulating unit 42 switches off the power supply to the pressure control valve 34 so that the pressure in the fuel line 20 and consequently in the inlet chamber 62 is only approximately 2 bar. This is the pressure at which just enough fuel is traveling through the flow throttle 26 and the branch line 24 into the drive/crank chamber 28 to assure the lubrication and cooling of the moving parts of the high-pressure fuel pump 22. The pressure level of 2 bar is labeled with the reference numeral 96 in FIG. 3.

As is also shown in FIG. 3, the pressure in the working chamber 60 (curve 88) during an intake stroke never falls below approximately 0.2 to 0.3 bar. At a pressure in the inlet chamber 62 of 2 bar, therefore, the pressure difference between the working chamber 60 and the inlet chamber 62 is at most approximately 1.7 to 1.8 bar. This pressure difference, however, is insufficient to lift the valve element 66 up from the valve seat 64 counter to the force exerted by the compression spring 72. Therefore in this instance, the inlet valve 78 does not open at all so that in addition, no fuel can flow into the working chamber 60.

The control and regulating unit 42 triggers the pressure control valve 34 as a function of the signals, which it receives from the position sensor 44. The fuel quantity supplied by the high-pressure fuel pump 22 can thus be adjusted as a function of the torque desired to by the operator of the internal combustion engine. The method with which the fuel system 10 is operated is stored as a computer program in memory of the control and regulating unit 42.

The foregoing relates to preferred exemplary embodiments of the invention, it being understood that other variants and embodiments thereof are possible within the spirit and scope of the invention, the latter being defined by the appended claims.

We claim:

1. A method for operating an internal combustion engine, in particular with direct injection, in which a first fuel pump (16) delivers fuel (14) from a fuel tank (12) and in which at least a part of the delivered fuel (14) travels on via at least one inlet valve (78) into at least one working chamber (60) of a second fuel pump (22) embodied as a positive-displacement pump, which delivers the fuel to a fuel accumulation line (36), the method comprising opening the inlet valve in response to a particular pressure difference between the working chamber (60) and a region (62, 76, 20) upstream of the inlet valve (78), and changing the pressure upstream of the inlet valve (78) in order to change the relative opening duration (90, 94) of the inlet valve (78) and therefore the fuel quantity arriving into the working chamber (60) of the second fuel pump (22).

2. The method according to claim 1, wherein, in order to achieve a maximal opening duration (90) of the inlet valve (78), the pressure in the region (20, 62, 76) upstream of the inlet valve (78) is increased to a pressure (86), which approximately corresponds to the maximal permissible pressure for the first fuel pump (16).

3. The method according to claim 1, wherein, in order to achieve a minimal opening duration of the inlet valve (78), the pressure in the region (20, 62, 76) upstream of the inlet valve (78) is reduced to a pressure (96), which approximately corresponds to the minimal pressure required for a lubrication of the second fuel pump (22).

4. The method according to claim 2, wherein, in order to achieve a minimal opening duration of the inlet valve (78), the pressure in the region (20, 62, 76) upstream of the inlet valve (78) is reduced to a pressure (96), which approximately corresponds to the minimal pressure required for a lubrication of the second fuel pump (22).

5. The method according to claim 1, wherein the inlet valve (78) is not opened when the pressure in the region (20, 62, 76) upstream of the inlet valve (78) is minimal.

6. The method according to claim 2, wherein the inlet valve (78) is not opened when the pressure in the region (20, 62, 76) upstream of the inlet valve (78) is minimal.

7. The method according to claim 3, wherein the inlet valve (78) is not opened when the pressure in the region (20, 62, 76) upstream of the inlet valve (78) is minimal.

8. The method according to claim 1, comprising at least indirectly using the desired driving torque of the engine to determine a reference opening duration of the inlet valve (78) of the second fuel pump (22) and/or a reference pressure in a region (20, 62, 76) upstream of the inlet valve (78) of the second fuel pump (22).

9. The method according to claim 2, comprising at least indirectly using the desired driving torque of the engine to determine a reference opening duration of the inlet valve (78) of the second fuel pump (22) and/or a reference pressure in a region (20, 62, 76) upstream of the inlet valve (78) of the second fuel pump (22).

10. The method according to claim 3, comprising at least indirectly using the desired driving torque of the engine to determine a reference opening duration of the inlet valve (78) of the second fuel pump (22) and/or a reference pressure in a region (20, 62, 76) upstream of the inlet valve (78) of the second fuel pump (22).

11. The method according to claim 5, comprising at least indirectly using the desired driving torque of the engine to determine a reference opening duration of the inlet valve (78) of the second fuel pump (22) and/or a reference pressure in a region (20, 62, 76) upstream of the inlet valve (78) of the second fuel pump (22).

12. A computer program, suitable for executing the method according to claim 1, when it is run on a computer.

13. A computer program, suitable for executing the method according to claim 3, when it is run on a computer.

14. A computer program, suitable for executing the method according to claim 8, when it is run on a computer.

15. The computer program according to claim 12, which is stored in a memory, in particular a flash memory.

16. A control and/or regulating unit (42) for controlling and/or regulating at least one function of an internal combustion engine, comprising a computer program suitable for executing the method of claim 1.

17. A fuel system (10) for an internal combustion engine, in particular with direct injection, the system comprising
a fuel tank (12),
a first fuel pump (16) that delivers from the fuel tank (12),
a second fuel pump (22) embodied as a positive-displacement pump with at least one working chamber (60),
at least one inlet valve (78) connecting the inlet side of the at least one working chamber (60) to the first fuel pump (16),
a fuel accumulation line (36) connected on the outlet the side of the at least one working chamber (60),
the inlet valve being adapted to open when a particular pressure differential exists between the working chamber (60) and a region (20, 62, 76) upstream of the inlet valve (78) and
a pressure adjusting device (34) operable to adjust the pressure in the region (20, 62, 76) upstream of the inlet valve (78), whereby influence can be exerted on the relative opening duration (90, 94) of the inlet valve (78) and on the quantity of fuel arriving into the working chamber (60) of the second fuel pump (22).

18. The fuel system according to claim 15, wherein the inlet valve includes a prestressed check valve (78).

19. The fuel system (10) according to claim 15, wherein the pressure adjusting device includes an electrically adjustable pressure control valve (34), which is connected on the outlet side to a return (30).

20. The fuel system (10) according to claim 16, wherein the pressure adjusting device includes an electrically adjustable pressure control valve (34), which is connected on the outlet side to a return (30).

21. The fuel system (10) according to claim 15, wherein the inlet valve (78) is embodied so that it remains closed when a pressure (96) in the region (20, 62, 76) upstream of the inlet valve lies in the vicinity of the minimal opening pressure of the pressure control valve (34).

22. The fuel system (10) according to claim 15, wherein the inlet valve (78) is embodied so that it is open essentially during the entire intake stroke of the second fuel pump (22) when a pressure (92) in the region (20, 62, 76) upstream of the inlet valve (78) lies in the vicinity of the maximal opening pressure of the pressure control valve (34).

23. The fuel system (10) according to claim 15, wherein the opening pressure (96) of the pressure control valve (34) is minimal when it is without power.
